(19) United States
(12) Patent Application Publication
(10) Pub. No.: US 2011/0016380 A1
(43) Pub. Date: Jan. 20, 2011

(54) FORM EDITING APPARATUS, FORM EDITING METHOD, AND STORAGE MEDIUM

(75) Inventor: Hajime Ohno, Fujisawa-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/836,368

(22) Filed: Jul. 14, 2010

(30) Foreign Application Priority Data
Jul. 16, 2009 (JP) 2009-168003

(51) Int. Cl. G06F 3/14

(52) U.S. Cl. 715/223

(57) ABSTRACT

The form editing apparatus of the present invention includes a correlation calculation section 507 that calculates the correlation between fields, an arranging section 505 that arranges the fields in a form so as to acquire a gap of each line in which the fields are arranged, and a gap adjusting section 508 that selects a plurality of candidate fields having a length smaller than the gap so as to move one field among the selected plurality of candidate fields to the gap based on the correlation.

### BACKGROUND OF THE INVENTION

1. Field of the Invention

The present invention relates to a form editing apparatus, a form editing method, and a storage medium. In particular, the present invention relates to a form editing apparatus that arranges a plurality of fields in a form such as a document, a form editing method, and a storage medium.

2. Description of the Related Art

Conventionally, when the documents for government offices and companies are generated, a person(s) writes necessary matters on books/slips which are sold by stationary makers or on papers of the organization's own making. Since computers become widely employed, the documents have been generated by the computers. In the early days of computers, all processes required for the output of the documents, such as the arrangement and design of characters, ruled lines, acquisition/search/analysis/calculation of data, and the like have been carried out by programs. Since the professionals (e.g., programmers) had to develop as many independent programs as the number of the kind of the documents, much cost has been incurred for the generation of the documents.

Then, document design processing for determining the appearance of a document and document output processing for printing data sent thereto have been separated. In addition, document editing software (document editor) allows a user to create the contents of a document displayed on a graphic screen by manipulating a mouse. With this arrangement, document design can even be done by people who are not professionals, whereby the cost for generating a document has been reduced.

The most costly steps of generating a document form using a document editor are the operation of arranging parts of a document (e.g., field graphics) and the operation of associating field graphics with data. In order to further reduce cost, a technique is available for reading data items for automatic field arrangement.

In the simplest example of a technique for automatically arranging fields, the sizes of the field graphics are estimated based on the attributes and the like of each item of data to sort the field graphics from the upper left to the right direction. There has been known a technique in which, when a field reaches to the right end, the next field graphic is sorted from the left end in the downward direction. There has also been known a technique in which, when repeated data items are found, they are collected in a table (e.g., Patent Document 1: Japanese Patent Laid-Open No. 2004-157927). As a technique for an image forming apparatus besides the field of the document, there has been known a technique in which an operation for moving a part (e.g., character string, image, etc.) of an electronic document at a location posterior to a space to the space in the electronic document is repeated to reduce the total number of document pages (e.g., Patent Document 2: Japanese Patent Laid-Open No. 2006-48520).

However, in the technique for reading the aforementioned data items for the automatic field arrangement and in the technique disclosed in Patent Document 1, problems arise in that unwanted space is provided on the right side. In other words, these techniques may result in the generation of unwanted space, and thereby the problems occur in that the amount of information to be transmitted is limited. In the technique disclosed in Patent Document 2, the parts of a document are moved without considering the contents thereof. Consequently, it is highly probable that a part with a different content would be sorted on the sheet of a paper, resulting in the degradation of the readability of information by a reader.

### SUMMARY OF THE INVENTION

In order to solve the aforementioned problems, according to an aspect of the present invention, a form editing apparatus that arranges a plurality of fields in a form is provided which includes a correlation calculation unit that calculates the correlation between the plurality of fields, an arranging unit that arranges the fields in the form so as to acquire a gap for each line in which the fields are arranged, and a gap adjusting unit that selects a plurality of candidate fields having a length smaller than the gap so as to move one field among the selected plurality of candidate fields to the gap based on the correlation.

In comparison with the prior art, the document editor of the present invention can generate a legible document containing a lot of information on the small sheet of paper with reduced cost.

Further features of the present invention will become apparent from the following description of exemplary embodiments with reference to the attached drawings.

### BRIEF DESCRIPTION OF THE DRAWINGS

FIG. 1A is a schematic diagram illustrating a configuration of a system to be used according to an embodiment of the present invention.

FIG. 1B is a block diagram illustrating a hardware configuration of a PC 101 shown in FIG. 1A.

FIG. 2 is a part of the ER diagram (Entity Relation Diagram) of the DB 102.

FIG. 3 is a view showing an example of a table to be stored in the DB 102.

FIG. 4 is a software block diagram illustrating a configuration of a document editor 501.

FIG. 5 is a view showing a GUI screen of the document editor 501.

FIG. 6 is a flowchart showing processing according to an embodiment of the present invention.

FIG. 7 is a view showing data item to be read from the DB in step S701 shown in FIG. 6.

FIG. 8 is a flowchart showing group search/setting processing.

FIG. 9 is a view showing the change of the field configuration before and after processing shown in FIG. 8.

FIG. 10 is a flowchart showing calculation/setting processing of data association.

FIG. 11 is a view showing the change of a correlation table as a result of processing shown in FIG. 10.

FIG. 12 is a view showing a concept of a collective concept dictionary.

FIG. 13 is a view showing how query is performed for the collective concept dictionary.

FIG. 14 is a flowchart showing gap adjusting processing for a group or an entire page.

FIG. 15A and FIG. 15B are views conceptually showing the state immediately before the execution of the processing in step S1507.

FIG. 16 shows a dialogue in which a user sets a weight coefficient of an evaluation function.

### DESCRIPTION OF THE EMBODIMENTS

Hereinafter, preferred embodiments of the present invention will now be described with reference to the accompanying drawings. In the present embodiment, as an example, assume the case in which, when the operating company for the member's-only internet auction implements a system in which the shipping slip for the goods is printed at the seller's home after a successful bid, the document designer newly designs the shipping slip using a document editor.

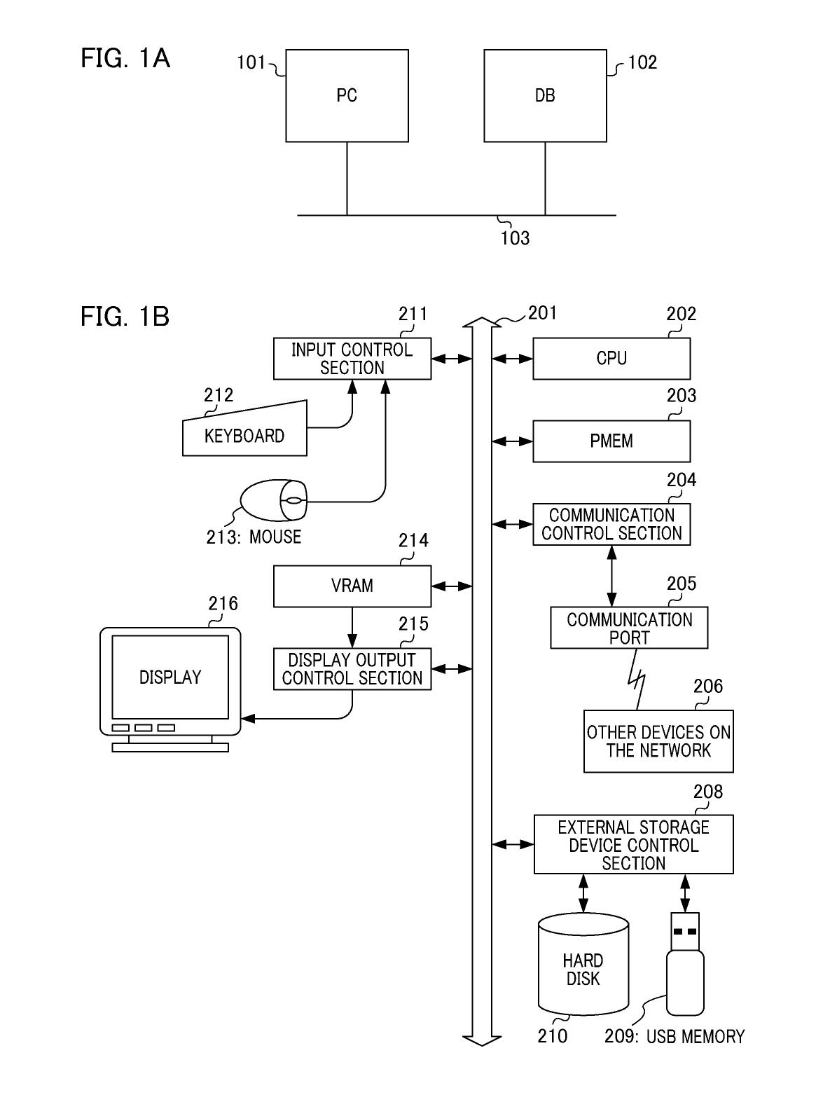

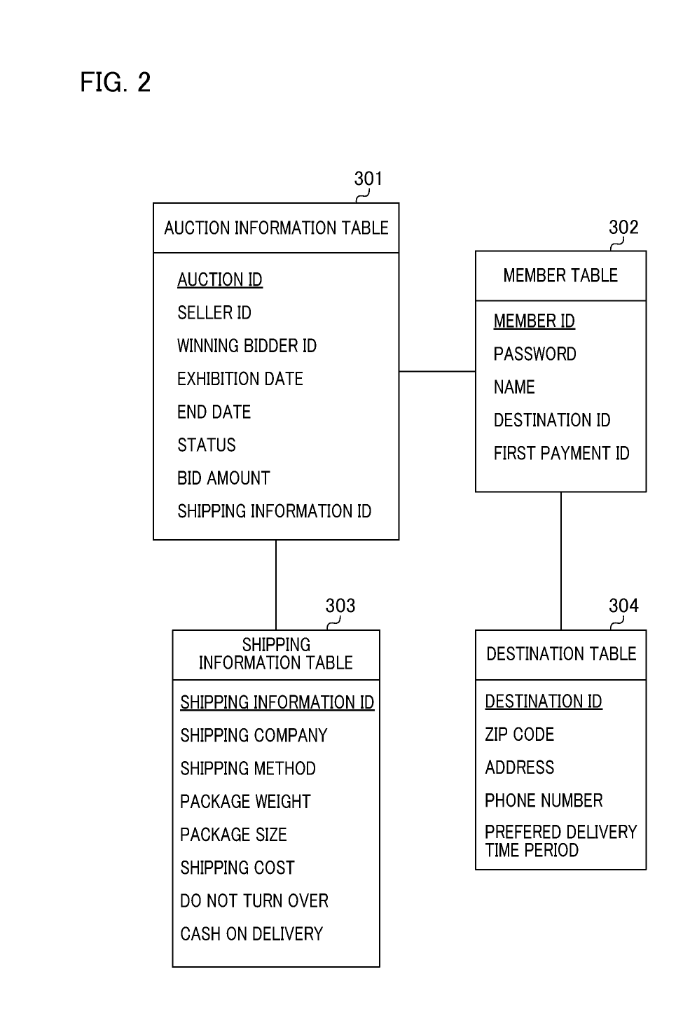

FIG. 1A is a schematic diagram showing an example of the system to which the form editing apparatus of the present invention is applied. As shown in FIG. 1A, the system of the present embodiment includes a personal computer (hereinafter referred to as “PC”) 101, a database (hereinafter referred to as “DB”) 102, and a LAN 103 that connects the PC 101 with the DB 102. A document designer uses the PC 101 to design a document through a document editor. The DB 102 stores data that is required for generating a document form using the document editor. The stored data will be described in detail in FIG. 2. The LAN 103 enables communication between the PC 101 and the DB 102.

FIG. 1B is a block diagram illustrating the hardware configuration of the PC 101 shown in FIG. 1A. As shown in FIG. 1B, the respective sections of the PC 101 are connected to each other via a system bus 201. The PC 101 includes a CPU 202, a program memory (PMEM) 203, a communication control section 204, an external storage device control section 208, an input control section 211, and a video image memory (VRAM) 214. The PC 101 further includes a display output control section 215, a printer control section 217, an external equipment control section 219, and an image reading equipment control section 220.

The communication control section 204 controls input/output data in a communication port 205. A signal output from the communication port 205 is transmitted to the communication port of other device(s) on the network 206 via a communication line. The external storage device control section 208 controls access to a disk for the data file, for example, a USB memory 209 or a hard disk (HDD) 210. An input device such as a keyboard 212, a mouse 213 and the like is connected to the input control section 211. An operator carries out the operation command and the like of the system by operating the input device.

The video image memory (VRAM) 214 is connected to a display 216 via the display output control section 215. Also, data to be displayed on the display 216 is expanded as bitmap data on the VRAM 214. The mouse 213 is a pointing device for instructing the processing of image information on the display 216. An operator can move the cursor on the display 216 at any X and Y direction by using the mouse 213 to thereby select the command'icons on the command menu. The operator can also provide instructions such as processing, editing, drawing position and the like.

The PMEM 203 appropriately selects and reads a program for the execution of the processing of the present embodiment from the hard disk 210, and the CPU 202 executes the program. The PMEM 203 stores data input from the keyboard 212 as code information. While in the present embodiment, a network such as a LAN is provided, the present invention is not limited thereto. The communication port 205 and the communication line to be connected to the communication control section 204 may be the generally-used public line.

FIG. 2 is a part of the ER diagram (Entity Relation Diagram) of the DB 102 according to the present embodiment. The DB 102 of the present embodiment includes an auction information table 301, a member table 302, a shipping information table 303, and a destination table 304. The auction information table 301 defines information of an auction which is being conducted or has been conducted. Among such information, a seller ID, a winning bidder ID, and a shipping method ID are associated with the shipping slip.

The seller ID and the winning bidder ID of the auction information table 301 are linked to the member table 302. Among information listed on the member table 302, a destination ID is associated with the shipping slip. The shipping information table 303 stores information regarding shipping of merchandise after a successful bid. Almost all of the information listed on the shipping information table 303 is used for the shipping slip. The destination table 304 stores information such as shipping address for merchandise auctioned or successfully bid on by a member. In these tables, the underlined items are primary keys.

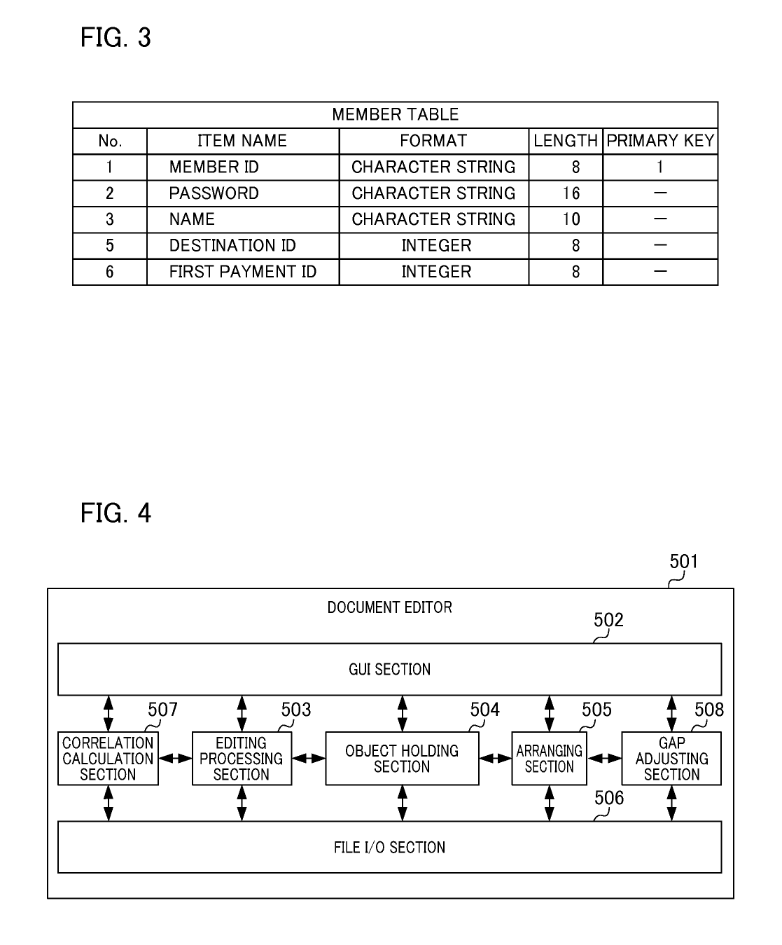

FIG. 3 shows a member table as an example of the table to be stored in the DB 102 of the present embodiment. In the member table, the format and the length for each item of the table are defined. Later, when the width of the field graphic of the data item is determined, such a length is used.

FIG. 4 is a software block diagram illustrating the configuration of the document editor 501. As shown in FIG. 4, the document editor 501 is configured by a GUI section 502, an editing processing section 503, an object holding section 504, an arranging section 505, a correlation calculation section 507, a gap adjusting section 508, and a file I/O section 506.

The GUI section 501 displays an object based on information held by the object holding section 504, and conveys a user input to the editing processing section 503 or the arranging section 505. The editing processing section 503 operates object information held by the object holding section 504 in response to a user's request for addition, deletion, and change of the object. The object holding section 504 holds object information, and provides such information to each section or causes each section to process such information. The correlation calculation section 507 calculates and determines the correlation between two data items. The arranging section 505 and the gap adjusting section 508 perform automatic arrangement processing, which are the characteristics of the present embodiment. The details of automatic arrangement processing will be described below. The file I/O section 506 reads and writes a configuration file, data file, form file, and the like based on the request received from each section.

Here, the relationship between FIGS. 1A, 1B, 2, 3, and 4 will now be described. The document editor shown in FIG. 4 is stored in the HDD 210 in an initial state. When a user provides instructions to activate the document editor through the keyboard 212 or the mouse 213, the CPU 202 reads the executable file of the document editor from the HDD 210 to thereby arrange it on the PMEM 203. When the arrangement is completed, the CPU 203 starts processing in accordance with the execution command group of the arranged document editor. The GUI section 502 controls the input control section 211 and the VRAM 214.

The file I/O section 506 controls the communication control section 204 and the external storage device control section 208 to perform input and output of data. At this time, the respective tables shown in FIG. 2 are stored in the DB 102. Under the control of the file I/O section 506, the document editor specifies the required item name to the DB 102 via the LAN 103 for performing a query. In response to the request, the DB 102 temporarily configures the table shown in FIG. 3 therein and returns it to the PC 101. The returned table is arranged on the PMEM 203 by the object holding section 504, so that the returned table is referenceable from other modules of the document editor.

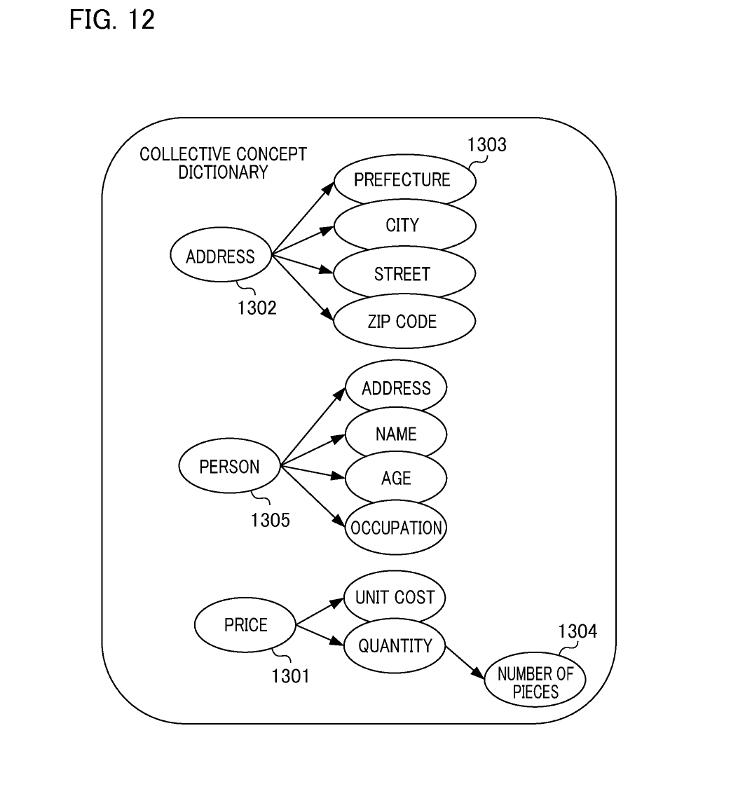

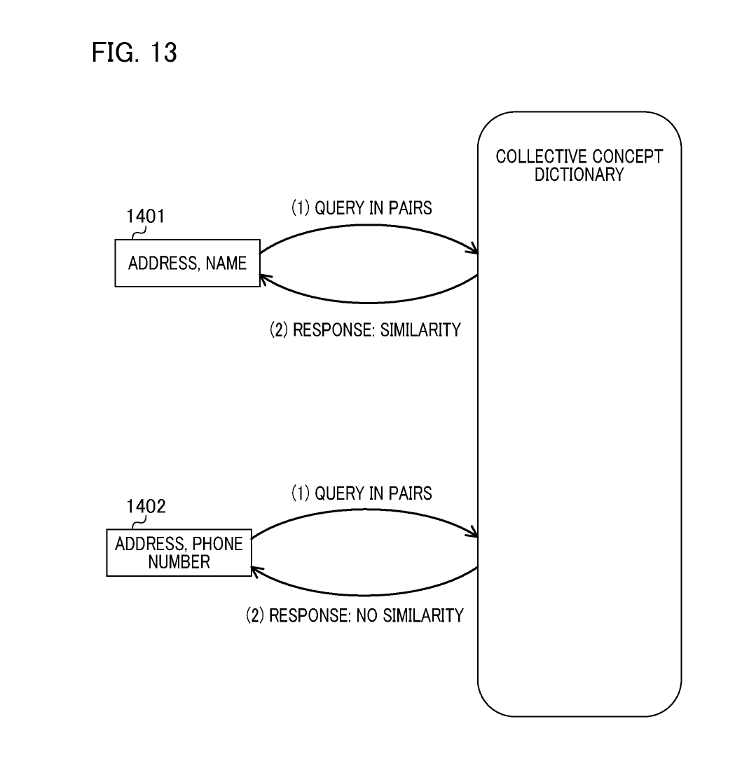

The collective concept dictionary to be described below (FIGS. 12 and 13) is also stored in the HDD 210 as a file. Since the collective concept dictionary is a very large file, the PMEM 203 does not read the entire collective concept dictionary. Only when needed, the file I/O section 506 accesses the required part of the file to thereby acquire the required results.

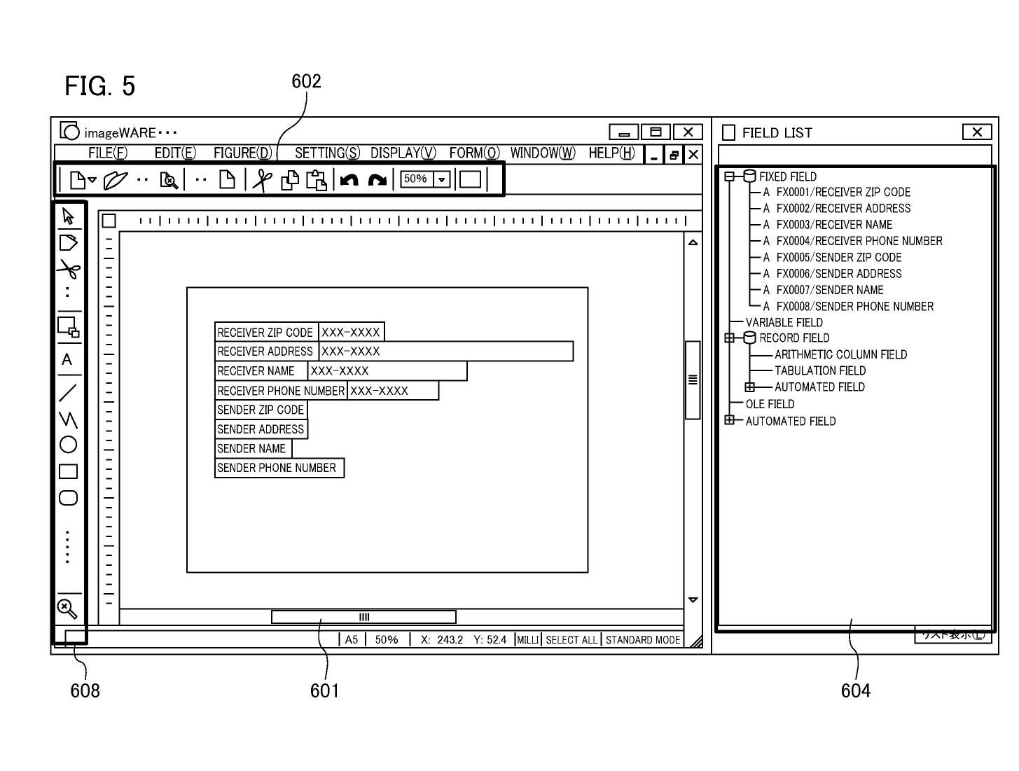

FIG. 5 is a view showing the GUI screen of the document editor 501. The GUI screen of the document editor 501 is configured by a drawing area 601 which is an area for designing a document form, a command bar 602, a toolbar 603, and a field list area 604. An operator arranges a field graphic and a static graphic object in the drawing area 601 so as to make a format, border line, size, and the like more appealing. The operator pushes the buttons on the command bar 602 to thereby enable the execution of a command depending on the pushed button. By pushing the buttons on the toolbar 603, the operator can apply the drawing element to the drawing area 601 or apply coloration thereto depending on the pushed button. Among them, the rightmost button is a button for executing automatic layout processing which is a characterizing part of the present embodiment.

The field list area 604 displays data items read from an external file or DB in a list as objects under the name of “field”. When an operator drags and drops these objects in the drawing area 601, he can manually produce a field graphic.

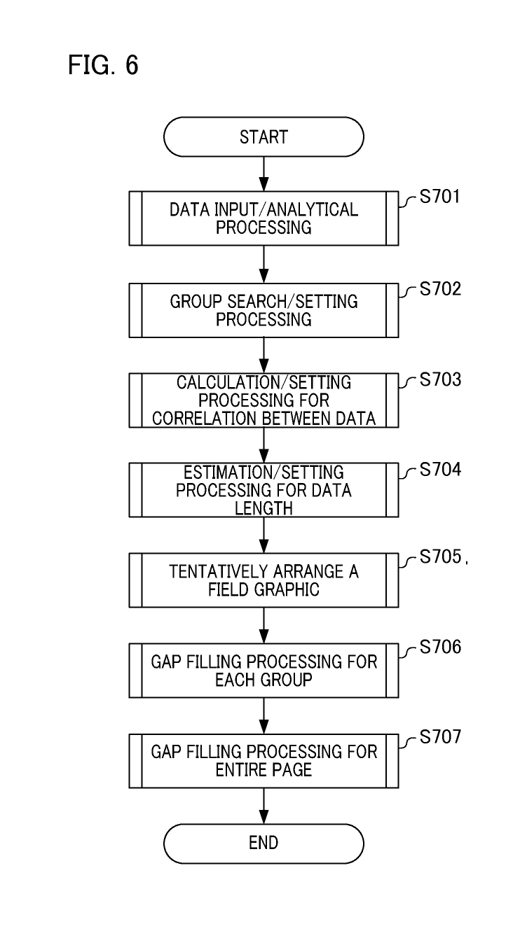

FIG. 6 is a flowchart showing processing of the present embodiment. When an operator pushes the rightmost button on the command bar 602, processing starts. First, the editing processing section 503 captures data items from the data source (external file, DB, etc.) specified by the operator, separates them as fields, and stores them in a memory (step S701). From the fields stored on the memory, the editing processing section 503 searches for a field group used as a group and allocates an identifier, which indicates that the searched field belongs to a specific group, to the searched field (step S702). The correlation calculation section 507 calculates the correlation between data, and stores it to a correlation table (step S703). The correlation table is utilized for gap adjusting processing to be described below. Then, the correlation calculation section 507 estimates the data length for each field, and sets the estimated value as the data length (step S704). When data items are captured from a CSV file, the correlation calculation section 507 may read additional sample data to thereby estimate the data length from the maximum length of the read sample data. In the present embodiment, the data items are captured from the DB, so that the data length is already known. Hence, the correlation calculation section 507 sets the data length of the DB as the data length of the field without performing any special estimation processing.

Subsequently, the arranging section 505 tentatively arranges field graphics in a form (step S705). First, the arranging section 505 sorts the fields such that the fields of the same group are presented in a sequential order. Next, the arranging section 505 arranges the field graphics in a packed manner from the upper left of the drawing area on a paper to a horizontal direction in a field sequential order. When the field graphics come to the end of a line, the line break is made and the field graphics are arranged from the next line in a packed manner. The arranging section 505 repeats the process for the tentative arrangement. Next, the gap adjusting section 508 fills the gap in each group (step S706), and fills the gap with respect to an entire page (step S707). Since both of the processing procedures are substantially the same, the details of which will be collectively described below.

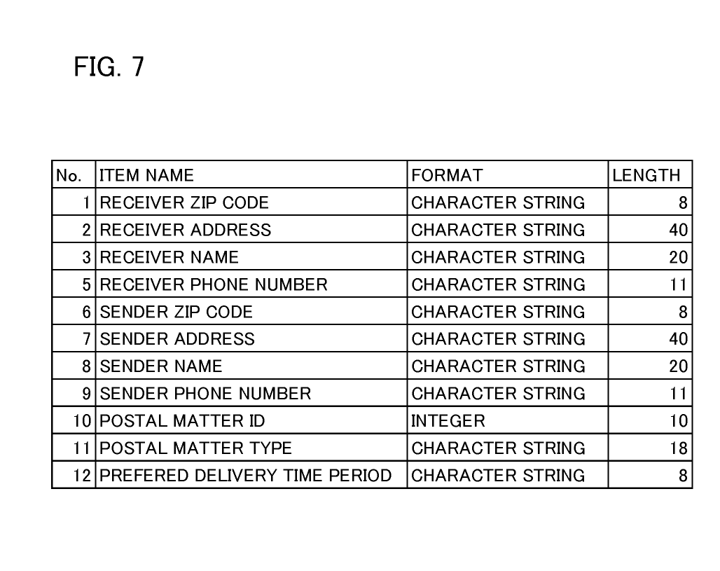

FIG. 7 is a view showing data items to be read from the DB in step S701 of FIG. 6. By issuing the SQL statement to the DB, the document editor combines the tables in a desired form for acquisition. In this example, the document editor substitutes a sender for a seller and substitutes a receiver for a winning bidder with the aid of the SQL.

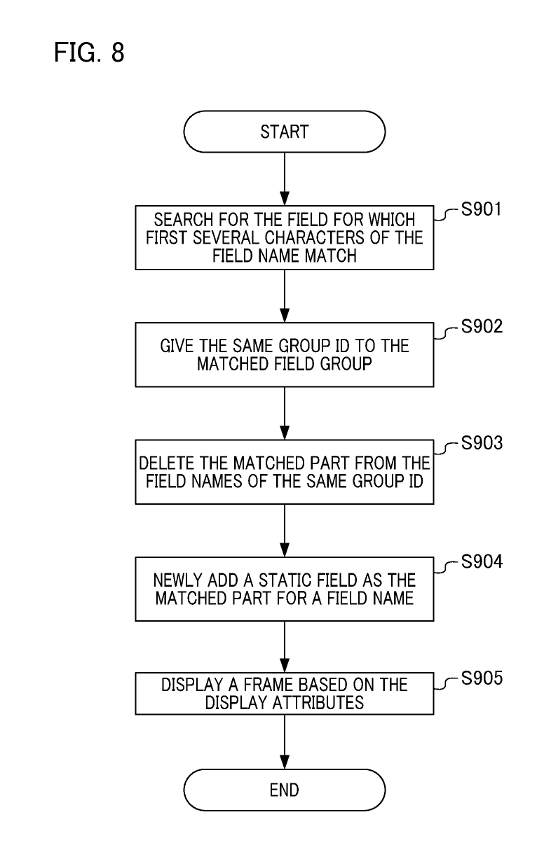

FIG. 8 is a flowchart showing group search/setting processing. First, the editing processing section 503 sequentially searches for the field names, i.e., data item names in each field, to find a field in which the first several characters match (step S901). The editing processing section 503 gives a matching character string to a matched field group (step S902) as a group ID. The editing processing section 503 deletes matched first character string from the field names of the fields having the same group ID (step S903).

Since the field names are described on a document as a static character string, processing in step S903 is helpful in conserving space. Here, the term “static” as used herein means “not having portions into which data is entered”. For example, in the present embodiment, the character of the actual address portion in “receiver address” changes each time a document is generated for data acquisition, whereas the field character “receiver”, indicating a group, is always constant. This is defined as “static”. For comprehensively representing a group for later automatic arrangement, the editing processing section 503 newly adds a static field in the upper left of the document to give a field name with the same group ID (step S904). Then, the GUI section 502 displays a frame based on the display attributes (step S905).

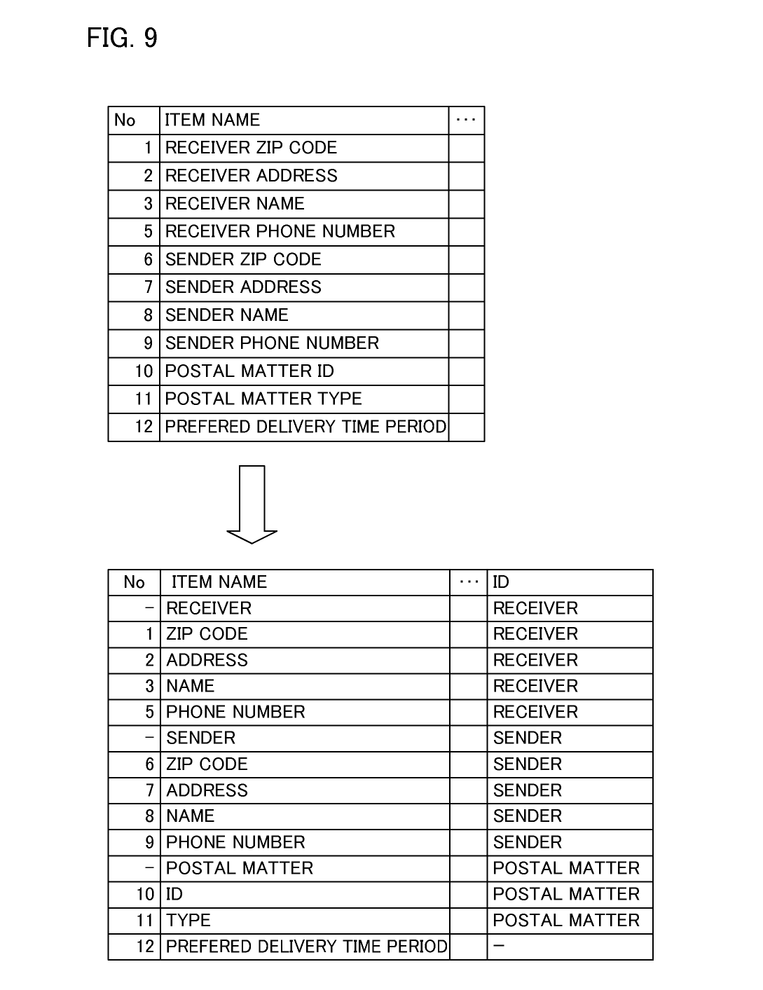

FIG. 9 is a view showing the change in the field configuration before and after group search/setting processing from step S901 to step S904 in FIG. 8. The upper table shows the state before processing, whereas the lower table shows the field configuration after processing. In the lower table, group IDs are added as common attributes, the matched portions are deleted from the field names, and a static field representing a group is added.

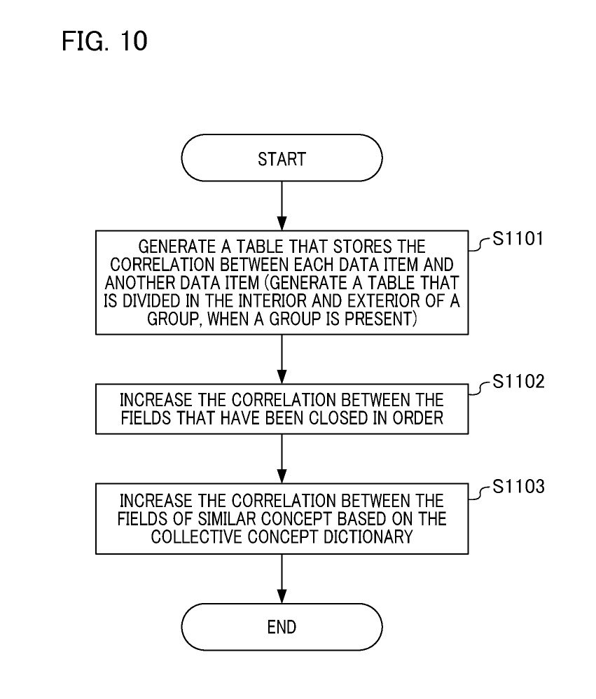

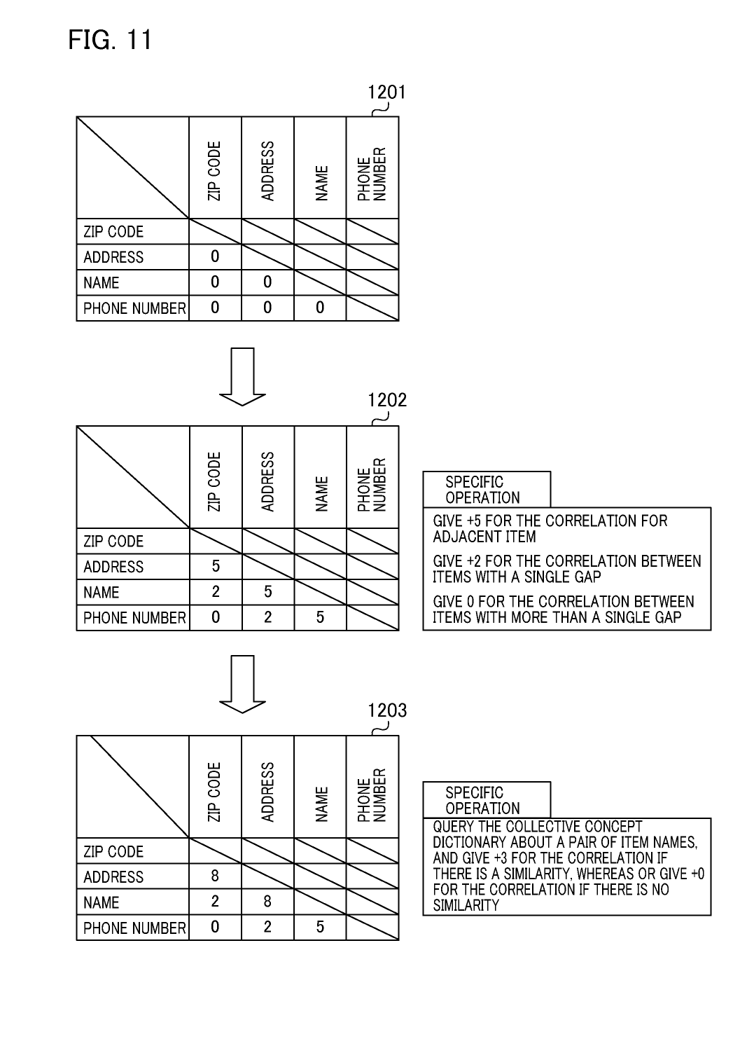

FIG. 10 is a flowchart showing calculation/setting processing for data association. First, the correlation calculation section 507 generates a table that stores the correlation between data items between two fields (step S1101). FIG. 11 is a view showing an example of the table that has been generated by the processing in step S1101. The correlation calculation section 507 gives the degree of correlation by estimating that two data lying close to the field order exhibits high association (step S1102). The correlation calculation section 507 queries the collective concept dictionary about a similarity between each of pairs consisting of two data items listed in the table, and gives the correlation if there is a similarity (step S1103). FIG. 11 shows the change in the correlation table due to calculation/setting processing for data association, and shows tables with respect to data items of the receiver group. More specifically, a table 1201 is a table that has been generated by the process in step S1101. In the table 1201, all of the correlations are set to 0 as an initial setting. A table 1202 is a table after the correlations have been given to the fields in close order by the process in step S1102. A table 1203 is a table after the correlations have been given to the pair of zip code-address fields that have been recognized by the process in step S1103 to be correlated.

FIG. 12 is a view showing the concept of the collective concept dictionary. The collective concept dictionary is configured by a collection of words in a tree structure, including a broader abstract conceptual word such as a parent node 1302 and a narrower concrete word such as a child node 1303 and a grandchild node 1304.

FIG. 13 is a view showing how a query is performed for the collective concept dictionary. As shown in FIG. 13, a query is performed for two words as a pair. When the pair of words, which is a query parameter, is found at a parent-child node or a brother node in the collective concept dictionary, the answer is that there is a similarity therebetween. In the case of a query 1401, address and name become a brother node in a tree 1305, and thus there is a similarity therebetween. On the other hand, in the case of a query 1402, a pair of address and phone number is not present in any of the trees as a parent-child node or a brother node, thus there is no similarity therebetween.

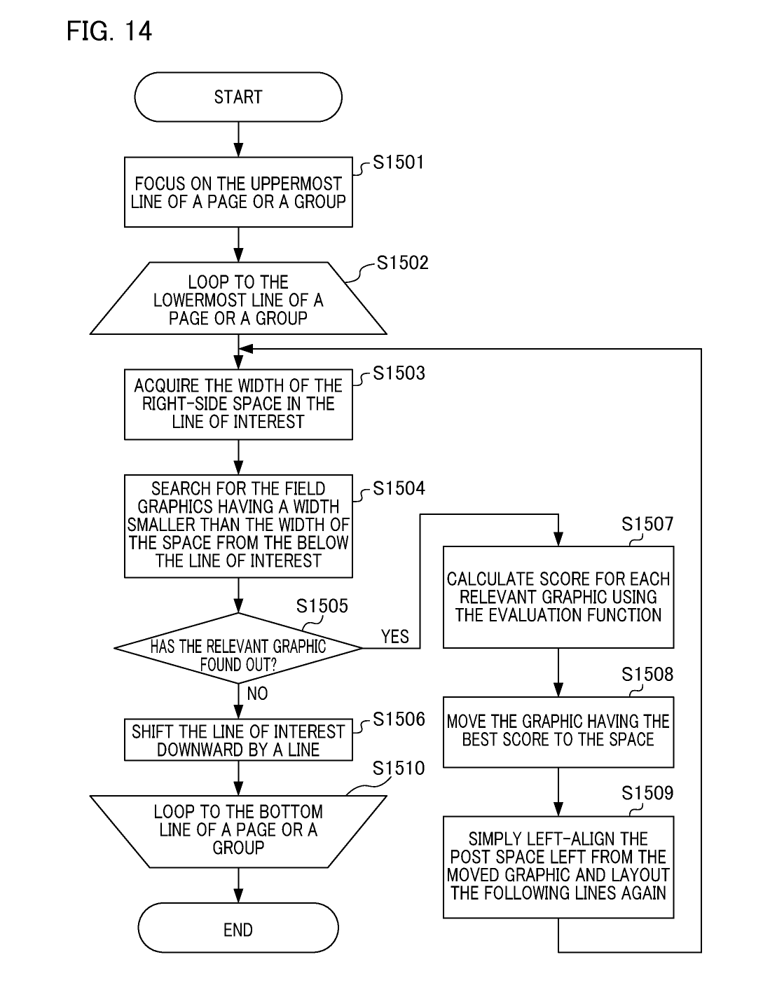

FIG. 14 is a flowchart showing gap adjusting processing for a group or an entire page. First, the gap adjusting section 508 sets a variable representing the position currently being subjected to gap adjusting processing (hereinafter referred to as “line of interest”) to the uppermost line (step S1501). Subsequently, the gap adjusting section 508 repeats processing by shifting the line of interest line-by-line, and terminates processing when the line of interest reaches to the bottom line (step S1502). In other words, the line of interest is the line at the top row in an unprocessed document.

The gap adjusting section 508 acquires the length of the right-side space (gap) in the line of interest (step S1503). The gap adjusting section 508 searches for the candidate field graphics having a length smaller than the length of a space from the below the line of interest (step S1504). When the candidate field graphics are found, the gap adjusting section 508 executes a best field graphic selection routine from step S1507 to step S1509 (step S1505). When no candidate field graphic is found, the space of the line of interest cannot be filled, and the process advances to step S1506 (step S1505). The gap adjusting section 508 shifts the line of interest downward by a line (step S1506).

When no applicable graphic is found, the gap adjusting section 508 calculates a score for each candidate field graphic, which has been found in step S1504, using an evaluation function to be described below (step S1507). The gap adjusting section 508 moves the best field graphic calculated in step S1507 to the right-side space of the line of interest (step S1508). The gap adjusting section 508 simply left-aligns the post space left from the moved field graphic (step S1509). The processing is repeatedly carried out until the line of interest reaches to the bottom line of a page or a group (step S1510), and then the processing is terminated.

The following formula represents an example of the evaluation function for deriving a score for each candidate field. A score is derived from the data correlation table and the length of space that have been calculated in advance. The evaluation function H is represented by the following formula:

H=(1−a)×Table (i, k)+a×Table (j, k)−b×(w−wₖ)

i: field graphic number of the left-side of space of interest

j: field graphic number of the upper-side of space of interest

k: candidate field graphic number

a: weight coefficient (left-side vs. upper-side)

b: weight coefficient (correlation vs. degree of filling)

Table (i, k): degree of correlation between ith and kth field graphics

Table (j, k): degree of correlation between jth and kth field graphics

w: length of space of interest

wₖ: length of candidate field

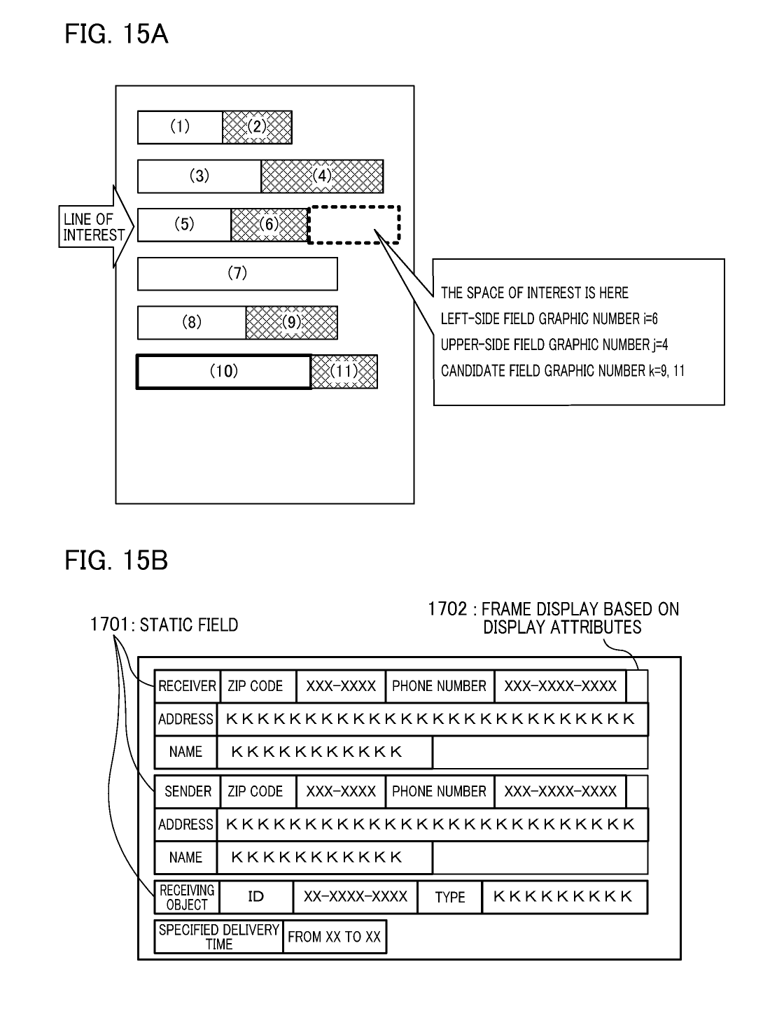

An example of gap adjusting processing according to the present embodiment will be described with reference to FIG. 15A. FIG. 15A is an example of the processing results when only one group is present. Since only one group is present, the process in step S706 in FIG. 6 is skipped, and the process in step S707 is carried out. Hereinafter, the details of the process in step S707 will be described.

In FIG. 15A, the line where the fields (5) and (6) are present is the “line of interest”. The right side of the field (6) is the “space of interest”. Hence, the length of the space of interest corresponds to w in the aforementioned formula. Since the left-side field of the space of interest is (6), i=6. Likewise, since the upper-side field of the space of interest is (4), j=4. Also, for the fields lying below the line of interest and having a length shorter than that of the space of interest, the fields (9) and (11) are the candidate fields. Hence, the evaluation function H is calculated two times when k=9 and when k=11, and thus one field to be moved to the space of interest is selected based on the two calculated scores.

For purposes of clarity of understanding, the following description will be given of the case where k=9. Table (i, k)=Table(6,9) in the evaluation function determines the correlation between the left-side field (6) and the candidate field (9) based on the table. Likewise, Table (j, k)=Table(4,9) determines the correlation between the upper-side field (4) and the candidate field (9). The weight coefficient a is a coefficient representing that against which correlation with either the left-side or the upper-side is weighted. If a<0.5, the left-side is weighted. (w−wₖ)=(w−w₉) represents that how much space is still remaining after the field graphic (9) is moved to the space of interest. Since more space worsens the score, (w−wₖ)=(w−w₉) is a minus term. The weight coefficient b represents that against which the strength of the correlation or the degree where no gap remains is weighted. The weight coefficients a and b are always positive or zero and do not become negative.

FIG. 15B is a view showing an example of the processing results of document data having a plurality of groups. As is described in FIGS. 8 and 9, in step S702 (step S901) in FIG. 6, groups of a receiver, a sender, and a receiving object are detected. The common parts (receiver, sender, and receiving object) are arranged at the static field 1701. At this time, the common parts (receiver, sender, and receiving object) may be displayed in a different color from other fields.

In S904, the display attributes are stored. In other words, as shown in FIG. 15B, the settings are configured such that each group is displayed with its field graphic encircled with a red frame, a dotted line frame, and the like and the frame is therefore differently displayed for each field graphic or each group based on the display attributes. It should be noted that the frame is not printed out, but may be printed out in response to a user's request.

Although in the example shown in FIG. 15B gap adjusting processing has been performed for a page, gap adjusting processing may also be performed for a plurality of pages. In other words, gap adjusting processing shown in FIG. 14 is performed for a plurality of pages, and then gap adjusting processing shown in FIG. 14 may be performed for each page.

Next, an example of specific numerical values for the coefficients and the like of the evaluation function in the aforementioned formula will now be described below. The effective printing width for a general A4-sized paper is about 190 mm. As a result of the measurement of some documents, the median of the field length is about 70 mm. Let it be assumed that 30 mm is the minimum value of the field length since few of the fields have the length less than 30 mm. As shown in FIG. 11, the Table (x, y) may represent a value of 0 to 8 inclusive. Here, for simplicity of explanation, let it be assumed that the weights of the correlation between the left-side field and the upper-side field are equal, i.e., a=0.5. In this case, the sum of the first term and the second term of the evaluation function, (1−a)×Table (i, k)+a×Table (j, k) may be a value of 0 to 8 inclusive.

Hence, the sum of the first term and the second term of the evaluation function of a plurality of candidate fields becomes a difference of eight at the maximum. In this case, a field having a high correlation is compared with a field having a low correlation. In principle, a highly correlated field should be moved whenever possible. When the difference in the length remaining on the right side is less than the minimum value (30 mm) of the field length, a highly correlated field is moved. Hence, b is kept as small as possible to reduce the effect of the third term. In other words, as an example, b is set smaller than 0.267 ( 8/30).

In contrast, the sum of the first term and the second term of the evaluation function of a plurality of candidate fields will have a difference of one at the minimum. When this degree of difference only exists in the correlation, it is impractical to take 30 mm as the difference of the length remaining in the right side. Hence, b is kept as large as possible to increase the effect of the third term. In other words, b is set greater than 0.033 ( 1/30). As described above, b may reasonably range from 0.033 to 0.267.

On the other hand, a ranges from 0 to 1 in the first instance. If a=0.01, (1−a)=0.99, then the difference in the weights between the left-side field and the upper-side field is about hundred times. In view of the fact that the maximum value of the Table is eight, the appropriate range of a is from 0.2 to 0.8, so that the difference in the weights between the first and second terms is four times or less and thus both of the terms may have an effect on the evaluation function.

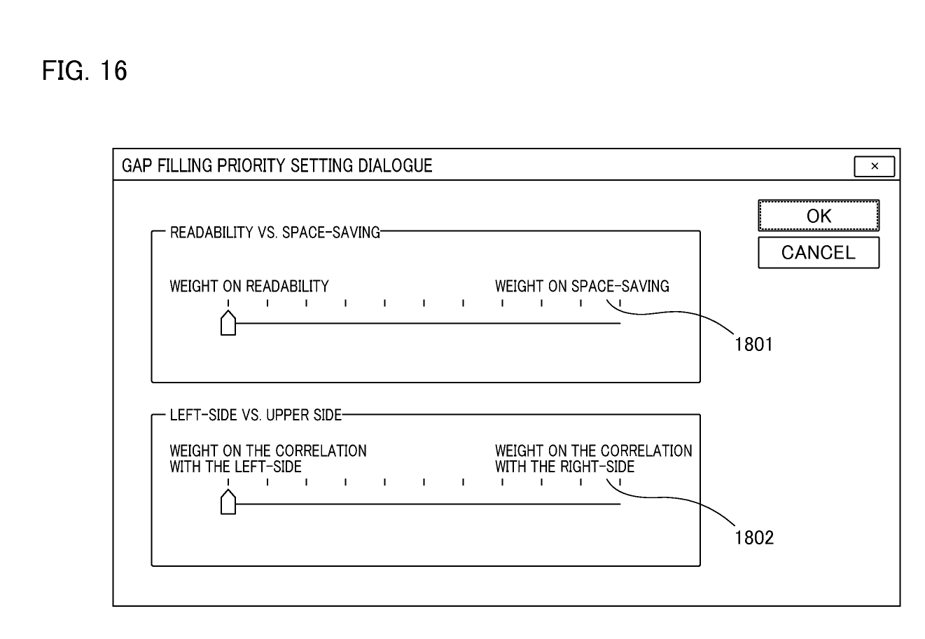

FIG. 16 shows a dialogue in which a user sets the weight coefficient of the evaluation function. A slider control 1801 is a unit for adjusting b. When the grip of the slider control 1801 is moved to the left, b approaches zero, whereas when it is moved to the right, b becomes a large positive number. A slider control 1802 is a unit for adjusting a. When the grip of the slider control 1802 is moved to the left, a approaches zero, whereas when it is moved to the right, a approaches one.

According to the document editor of the present invention, a field graphic may be laid out on a small sheet of paper in a readily readable manner with reduced efforts. It should be noted that although the present embodiment was described using an example in which the present invention is applied to a document, the present invention can be applied to any layout processing for arranging and displaying a plurality of items on a predetermined paper, such as layout processing for business cards in which a plurality of titles is described and the like.

The steps of the present invention can also be realized by causing a processing apparatus (CPU, processor) such as a personal computer and the like to execute software (computer program) acquired via the network or various storage medium. While in the embodiment of the present invention, a CSV file is applied as a used file, the present invention is not limited thereto, and may be applied to any application that can represent tabular data. More specifically, the present invention is applicable to EXCEL™ by Microsoft and the like.

While the embodiments of the present invention have been described with reference to exemplary preferred embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-168003 filed Jul. 16, 2009 which is hereby incorporated by reference herein its entirety.

What is claimed is:

1. A form editing apparatus that arranges a plurality of fields in a form, the form editing apparatus comprising:
a correlation calculation unit that calculates the correlation between the plurality of fields;
an arranging unit that arranges the fields in the form so as to acquire a gap of each line in which the fields are arranged; and
a gap adjusting unit that selects a plurality of candidate fields having a length smaller than the gap so as to move one field among the selected plurality of candidate fields to the gap based on the correlation.

2. The form editing apparatus according to claim 1, wherein the gap adjusting unit moves the one field to the gap based on a numerical value by multiplying the correlation by a weight function indicating that against which position of the candidate field is weighted.

3. The form editing apparatus according to claim 1, wherein the gap adjusting unit moves the one field to the gap based on a numerical value by multiplying the correlation by a weight function indicating that either the correlation between the plurality of candidate fields or a degree where no gap remains is weighted.

4. The form editing apparatus according to claim 1, wherein the correlation calculation unit determines a correlation based on the order of the plurality of fields and the similarity of the words of the item names of the fields.

5. The form editing apparatus according to claim 2, wherein the weight function is changeable.

6. The form editing apparatus according to claim 1, wherein the correlation calculation unit separates the plurality of fields into groups by field having a common attribute so as to determine the correlation between the fields for each of the groups.

7. A form editing method that arranges a plurality of fields in a form, the method comprising the steps of:
calculating the correlation between the plurality of fields;
arranging the fields in the form so as to acquire a gap of each line in which the fields are arranged; and
selecting a plurality of candidate fields having a length smaller than the gap so as to move one field among the selected plurality of candidate fields to the gap based on the correlation.

8. A storage medium storing a computer program for causing a computer to execute the form editing method according to claim 7.
